(19) United States
(12) Patent Application Publication
(10) Pub. No.: US 2007/0132707 A1
(43) Pub. Date: Jun. 14, 2007

(54) DISPLAY DEVICE AND METHOD OF DRIVING THE SAME

(75) Inventors: Uk-Chul CHOI, Cheonan-si (KR); Cheol-Woo PARK, Suwon-si (KR); Jae-Hyun CHO, Seoul (KR); Sung-Jin HONG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/548,539

(22) Filed: Oct. 11, 2006

(30) Foreign Application Priority Data
Dec. 13, 2005 (KR) 10-2005-122359

(51) Int. Cl. G09G 3/36

(52) U.S. Cl. 345/102

(57) ABSTRACT

In a display device and a method of driving the display device each having an improved image display quality, the display device includes the display panel assembly, a light emitting unit and a control unit. The display panel assembly has a plurality of unit pixels and displays an image. The light emitting unit is disposed under the display panel assembly to supply light to the display panel assembly, and has a plurality of light emitting diodes (“LEDs”) corresponding to a unit pixel group including a given number of the unit pixels. The control unit is electrically connected to the display panel assembly and the light emitting unit, and controls the unit pixels by arbitrary regions and the LEDs by arbitrary regions. Thus, a contrast ratio of the display device is increased to improve image display quality.

This application claims priority to Korean Patent Application No. 2005-122359, filed on Dec. 13, 2005, and all the benefits accruing therefrom under 35 U.S.C. §119, the contents of which in its entirety are herein incorporated by reference.

### BACKGROUND OF THE INVENTION

1. Field of the Invention

The present invention relates to a display device and a method of driving the display device. More particularly, the present invention relates to a display device for improving image display quality and a method of driving the display device for improving the image display quality.

2. Description of the Related Art

Generally, a liquid crystal display (“LCD”) device is a representative flat panel display device that displays images using electrical and optical characteristics of a liquid crystal. The LCD device has advantages of thin thickness, light weight structure, low power consumption and low driving voltage in comparison with a cathode ray tube (“CRT”) device. Thus, the LCD device has been used in many industrial fields and has been widely used for portable computers, communication devices, television sets, for example.

The LCD device includes an LCD panel and a backlight assembly. The LCD panel displays images using a light transmission rate of a liquid, and the backlight assembly is disposed under the LCD panel and supplies light to the LDC panel.

The LCD panel includes a first substrate, a second substrate and a liquid crystal layer. The first substrate has thin film transistors (“TFTs”) formed in a plurality of unit pixels included in the first substrate, the second substrate has a color filter, and the liquid crystal layer is interposed between the first and second substrates. The color filter has a plurality of color pixels corresponding to the unit pixels, and the color pixels contain a red color filter, a green color filter and a blue color filter.

The backlight assembly has a light source for generating light required to display images on the LCD panel. The light source contains a cold cathode fluorescent lamp (“CCFL”), a flat fluorescent lamp (“FFL”) or a light emitting diode (“LED”), for example.

The LED of the light source may be made in a chip type, and may have high brightness and low power consumption. Thus, the LED has been used widely as the light source for the backlight assembly.

Recently, a color sequential LCD device, which may enhance a light transmission rate and may omit a process for forming a color filter, has been developed. The color sequential LCD device includes an LCD panel without any color filter and includes a backlight assembly individually driving a red LED, a green LED and a blue LED.

However, the color sequential LCD device has a disadvantage that a desired color may not be realized when a response speed of the LCD panel is not fast. Thus, an optically compensated bend (“OCB”) mode panel is used as the LOD panel. The QCB mode panel is a panel in which arrangements of liquid crystal molecules in a liquid crystal layer are in a splay state with two alignment layers formed on a first substrate and a second substrate, respectively, being parallel to each other before the OCB panel operates (e.g., absent an applied alignment voltage). When an alignment voltage, for example, a voltage of about 1.5 V to 2 V is applied to the OCB panel, the liquid crystal layer is converted from the splay state into a bend state so that the OCB panel is ready to operate.

Although the OCB panel has an advantage of a quick response speed, the OCB panel has a disadvantage of a low contrast ratio (“CR”). When the LCD has such a low CR, image display quality of the LCD may be deteriorated.

### BRIEF SUMMARY OF THE INVENTION

Example embodiments of the present invention provide a display device having an improved image display quality by changing a method of driving an LED to improve a contrast ratio.

Example embodiments of the present invention provide a method of driving the display device having the improved image display quality.

According to one aspect of the present invention, there is provided a display device. The display device includes a display panel assembly, a light emitting unit and a control unit. The display panel assembly includes a plurality of unit pixels and displays an image. The light emitting unit is disposed under the display panel assembly to supply light to the display panel assembly, and has a plurality of LEDs corresponding to a unit pixel group including a given number of the unit pixels. The control unit is electrically connected to the display panel assembly and the light emitting unit. The control unit individually controls the unit pixels by arbitrary regions and individually controls the LEDs by arbitrary regions.

In an example embodiment of the present invention, the LEDs may include a red LED, a green LED and a blue LED.

In an example embodiment of the present invention, the red LED, the green LED and the blue LED may sequentially generate light.

In an example embodiment of the present invention, the unit pixel group may include one unit pixel or nine numbers of the unit pixels.

According to another aspect of the present invention, there is a method of driving a display device. In the method of driving the display device, a red LED and unit pixels of a display panel corresponding to the red LED are controlled to display red color in an arbitrary first region. A green LED and unit pixels of the display panel corresponding to the green LED are controlled to display green color in an arbitrary second region. A blue LED and unit pixels of the display panel corresponding to the blue LED are controlled to display blue color in an arbitrary third region.

According to some example embodiments of the present invention, unit pixels of a display panel and LEDs are individually controlled so that a contrast ratio of a display device may be increased to improve image display quality.

### BRIEF DESCRIPTION OF THE DRAWINGS

The above and other features and advantages of the present invention will become more apparent by describing exemplary embodiments thereof with reference to the accompanying drawings, in which:

FIG. 1 is an exploded perspective view illustrating a display device in accordance with an exemplary embodiment of the present invention;

FIG. 2 is a block diagram of the display device shown in FIG. 1;

FIG. 3 is a plan view illustrating arrangements of LEDs included in a light generating unit of the display device shown in FIG. 1;

FIG. 4 is a perspective view illustrating a relationship between the LEDs and the unit pixels of the display device shown in FIG. 1;

FIG. 5A is a cross-sectional view illustrating displayed images by a method of driving a display device in accordance with an exemplary embodiment of the present invention; and

FIGS. 5B to 5D are cross-sectional views illustrating the method of driving the display device in order to display the images shown in FIG. 5A.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another member, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-section illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained with reference to the accompanying drawings.

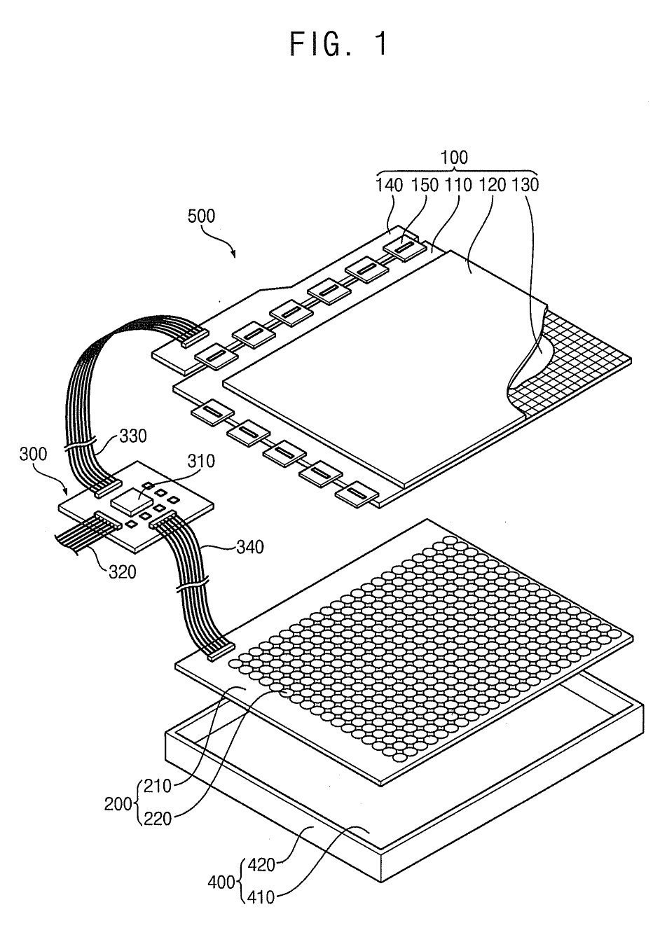

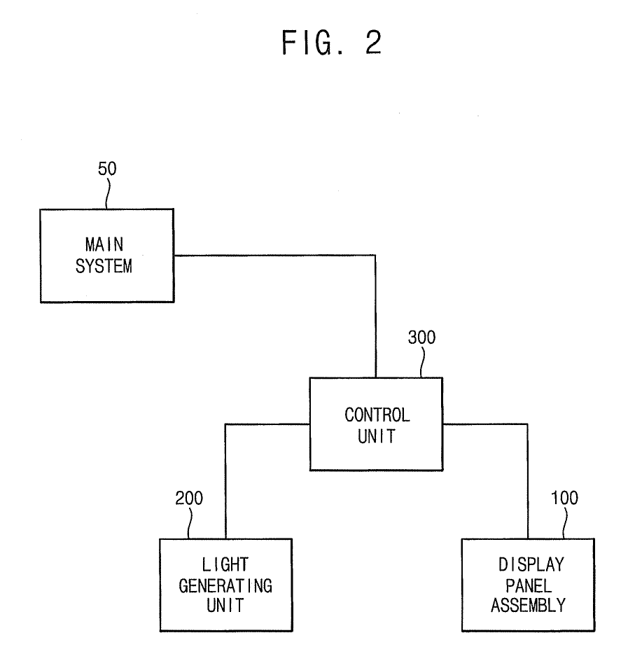

FIG. 1 is an exploded perspective view illustrating a display device in accordance with an exemplary embodiment of the present invention, and FIG. 2 is a block diagram of the display device shown in FIG. 1.

Referring to FIGS. 1 and 2, a display device 500 includes a display panel assembly 100, a light generating unit 200, a control unit 300 and a receiving container 400. The display device 500 displays images to an exterior space.

The display panel assembly 100 includes a display panel, a printed circuit board (“PCB”) 140 and a flexible circuit film 150. The display panel includes a first substrate 110, a second substrate 120 and a liquid crystal layer 130 interposed therebetween.

The first substrate 110 has a plurality of pixel electrodes arranged in a matrix, thin film transistors (“TFTs”) applying driving voltages to each of the pixel electrodes, and signal lines for operating the TFTs. The pixel electrodes are transparent and conductive.

The signal lines include a plurality of gate lines and a plurality of data lines. The gate lines and the data lines are formed to intersect each other, thereby forming a plurality of unit pixels. The TFT and the pixel electrode are formed in the unit pixel.

The second substrate 120 is disposed to face the first substrate 110. The second substrate 120 includes a common electrode disposed on a front face that faces the first substrate 110. The common electrode is transparent and conductive. The second substrate 120 in accordance with an exemplary embodiment of the present invention does not have a color filter.

The liquid crystal layer 130 is interposed between the first and second substrates 110 and 120, and is rearranged by a magnetic field formed between the pixel electrode and the common electrode. The rearranged liquid crystal layer 130 controls a transmission rate of light provided from outside of the liquid crystal layer 130.

In an exemplary embodiment of the present invention, an optically compensated bend (“OCB”) mode panel is used as the display panel. The OCB mode panel is a panel in which arrangements of liquid crystal molecules in a liquid crystal layer are in a splay state with two alignment layers formed on a first substrate and a second substrate, respectively, being parallel to each other before the OCB panel operates (e.g., before application of an alignment voltage). When an alignment voltage, for example, a voltage of about 1.5 V to 2 V is applied to the OCB panel, the liquid crystal layer is converted from the splay state into a bend state so that the OCB panel is ready to operate. Although the OCB panel takes a relatively long time in getting ready to operate, the OCB panel has an advantage of a quick response speed once ready to operate.

The PCB 140 includes a first driving circuit that processes signals, and the first driving circuit converts signals inputted from an outside of the first driving circuit into signals for displaying images. The PCB 140 is disposed under the first substrate 110 when the flexible circuit film 150 is bent toward a backside of the first substrate 110. The PCB 140 may include a data PCB and a gate PCB. In an exemplary embodiment of the present invention, the gate PCB is not formed in the display panel assembly 100 by forming additional signal lines on the first substrate 110 and the flexible circuit film 150.

The flexible circuit film 150 electrically connects the PCB 140 to the first substrate 110, and supplies signals generated from the PCB 140 to the first substrate 100. The flexible circuit film 150 may further include a driving chip that converts the generated signals from the PCB 140 into driving signals for driving the TFT. The driving chip may be formed on the flexible circuit film 150 or on the first substrate 110. The flexible circuit film 150, for example, may be a tape carrier package (“TCP”) or a chip on film (“COF”).

The light generating unit 200 is disposed under the display panel assembly 100, and includes a driving substrate 210 and a light emitting diode (“LED”).

The driving substrate 210 has a control line (not shown) for controlling the LED 220 and a source line (not shown) for emitting light from the LED 220.

A plurality of the LEDs 220 are disposed on the driving substrate 210 to be connected to the control line, thereby being controlled by the control line. The LEDs 220 are connected to the source line to receive source power. The plurality of the LEDs 220 may include a red LED, a green LED and a blue LED.

The control unit 300 is electrically connected to the display panel assembly 100 and the light generating unit 200 to control the display panel assembly 100 and the light generating unit 200.

The control unit 300 includes a second driving circuit 310, a first connector 320, a second connector 330 and a third connector 340.

The second driving circuit 310 is electrically connected to an exterior main system 50 (see FIG. 2) through the first connector 320, electrically connected to the PCB 140 of the display panel assembly 100 through the second connector 330, and electrically connected to the light generating unit 200 through the third connector 340.

The second driving circuit 310 receives an image signal from the main system 50 to generate an image control signal and a light source control signal. The image control signal is applied to the display panel assembly 100 to individually drive the TFT included in each unit pixel by arbitrary regions. The light source control signal is applied to the light generating unit 200 to individually drive the LED by arbitrary regions.

The receiving container 400 includes a bottom portion 410 and a side portion 420 extending from edges of the bottom portion 410. The bottom portion 410 and the side portion 420 together define a receiving space. The display panel assembly 100 and the light generating unit 200 are contained in the receiving space. In an exemplary embodiment of the present invention, the control unit 300 and the PCB 140 are disposed under the receiving container 400.

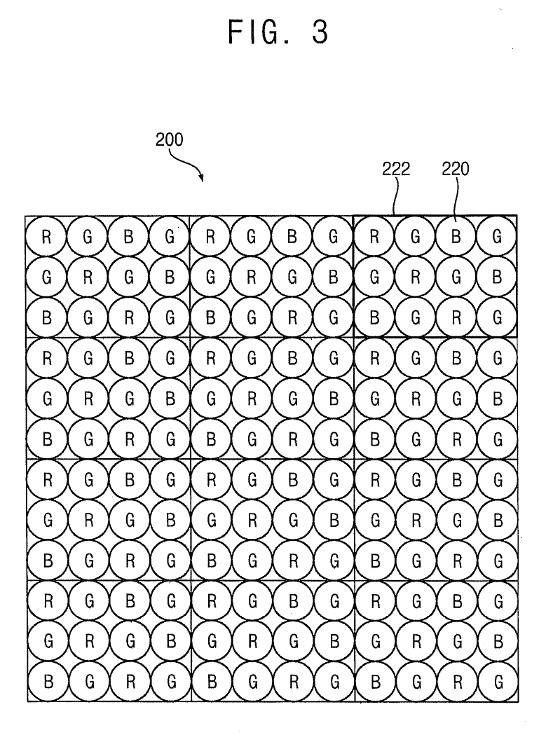

FIG. 3 is a plan view illustrating arrangements of LEDs included in the light generating unit 200 of the display device shown in FIG. 1.

Referring to FIG. 3, the light generating unit 200 includes a plurality of LEDs 220 disposed in a matrix. The LEDs 220 may include a red LED R, a green LED G and a blue LED B.

In an exemplary embodiment of the present invention, 3 row×4 column array of the LEDs 220 defines a unit block, and a plurality of the unit blocks (e.g., 12 unit blocks shown)e are repeatedly disposed in a matrix in the light generating unit 200. A red LED R, a green LED G, a blue LED B and a green LED G are disposed in order from left to right in a first row of each unit block. A green LED G, a red LED R, a green LED G and a blue LED B are disposed in order from left to right in a second row of each unit block. A blue LED B, a green LED G, a red LED R and a green LED G are disposed in order from left to right in a third row of each unit block.

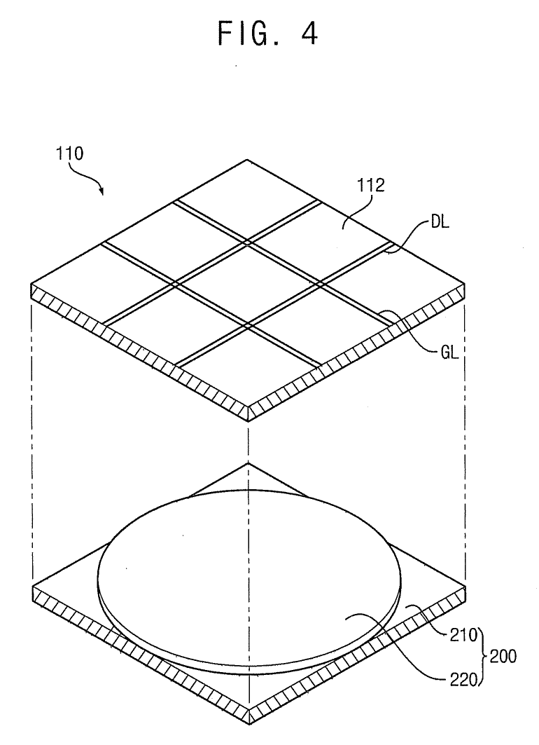

FIG. 4 is a perspective view illustrating a relationship between the LEDs 220 and the unit pixels of the display device shown in FIG. 1.

Referring to FIGS. 1 and 4, in an exemplary embodiment of the present invention, a plurality of LEDs 220 are disposed on the driving substrate 210. A plurality of data lines DLs and a plurality of gate lines GLs intersect each other to form a plurality of unit pixels 112 on the first substrate 110 that is disposed over the LEDs 220. In an exemplary embodiment of the present invention, the unit pixel 112 has a rectangular shape from a plan view.

Each of the LEDs 220 formed on the driving substrate 210 corresponds to a given number of the unit pixels 112. For example, one LED 220 may correspond to nine unit pixels 112. The nine unit pixels 112 may be disposed in a 3 row×3 column array, as illustrated in FIG. 4. Alternatively, each of the LEDs 220 may correspond to only one unit pixel 112.

The LEDs 220 formed on the driving substrate 210 are individually controlled by the control unit 300. For example, the control unit 300 controls some of the LEDs 220 to generate light, and simultaneously controls the other LEDs 220 not to generate light.

The unit pixels 112 formed on the first substrate 110 are also individually controlled by the control unit 300. That is, the control unit 300 individually drives the TFTs included in the unit pixels 112. For example, the control unit 300 controls the TFTs so that light may be transmitted only through some parts of the unit pixels 112. Particularly, when the LED 220 generates light, some of the nine unit pixels 112 transmit light, and simultaneously the other nine unit pixels 112 do not transmit light.

In addition, the control unit 300 controls the red LED R, the green LED G and the blue LED B so that the red LED R, the green LED G and the blue LED B may sequentially generate light. For example, the control unit 300 first controls the red LED R to generate light, secondly controls the green LED G to generate light, and finally controls the blue LED B to generate light. The control unit 300 controls the red LED R, the green LED G and the blue LED B so that the red LED R, the green LED G and the blue LED B may repeatedly generate light in such order. In an exemplary embodiment of the present invention, each of the red LED R, the green LED G and the blue LED B is driven at about 60 Hz.

According to the present exemplary embodiment of the present invention, as the control unit 300 individually drives the LEDs 220 of the light emitting unit 200 and the unit pixels 112 of the display panel assembly 100, regions through which light may be transmitted and regions through which light may not be transmitted are clearly differentiated, and thus a contrast ratio may be improved.

Referring now to FIGS. 1 to 4, in an exemplary embodiment of the present invention, a red LED R and unit pixels 112 of the display panel corresponding to the red LED R are controlled to display red color in an arbitrary first region.

Particularly, a first red LED disposed within the first region and a second red LED disposed across an interface between the first region and the other region are selected to generate red colored light. Red colored light generated from outside of the first region has to be blocked in order to display the red color only within the first region. Thus, unit pixels disposed outside of the first region out of the unit pixels 112 corresponding to the second red LED are controlled so that the red colored light generated from outside of the first region may be blocked. In an exemplary embodiment of the present invention, controlling the first and second red LEDs to selectively generate the red colored light and controlling the unit pixels 112 disposed outside of the first region to block the red colored light generated outside of the first region are simultaneously performed.

After displaying the red colored light in the first region, a green LED G and unit pixels 112 of the display panel corresponding to the green LED G are controlled to display green color in an arbitrary second region.

Particularly, a first green LED disposed within the second region and a second green LED disposed across an interface between the second region and the other region are selected to generate green colored light. Green colored light generated outside of the second region has to be blocked in order to display the green colored light only within the second region. Thus, unit pixels disposed outside of the second region out of the unit pixels 112 corresponding to the second green LED are controlled so that the green colored light generated outside of the second region may be blocked. In an exemplary embodiment of the present invention, controlling the first and second green LEDs to selectively generate the green colored light and controlling the unit pixels 112 disposed outside of the second region to block the green colored light generated outside of the second region are simultaneously performed.

Finally, a blue LED B and unit pixels 112 of the display panel corresponding to the blue LED B are controlled to display blue color in an arbitrary third region.

Particularly, a first blue LED disposed within the third region and a second blue LED disposed across an interface between the third region and the other region are selected to generate blue colored light. Blue colored light generated outside of the second region has to be blocked in order to display the blue color only within the third region. Thus, unit pixels disposed outside of the third region out of the unit pixels 112 corresponding to the second blue LED are controlled so that the blue colored light generated outside of the third region may be blocked. In an exemplary embodiment of the present invention, controlling the first and second blue LEDs to selectively generate the blue colored light and controlling the unit pixels 112 disposed outside of the third region to block the blue colored light generated outside of the third region are simultaneously performed.

The display device 500 performs such operations described above so that the display device 500 may display images having various colors. In an exemplary embodiment of the present invention, the red LED R, the green LED G and the blue LED B are driven at about 60Hz.

In the above-described exemplary embodiment, the red LED R, the green LED G and the blue LED B sequentially generate light in such order, however the light generating order may be changed.

Hereinafter, the above-described method of driving the display device will be illustrated with reference to additional drawings.

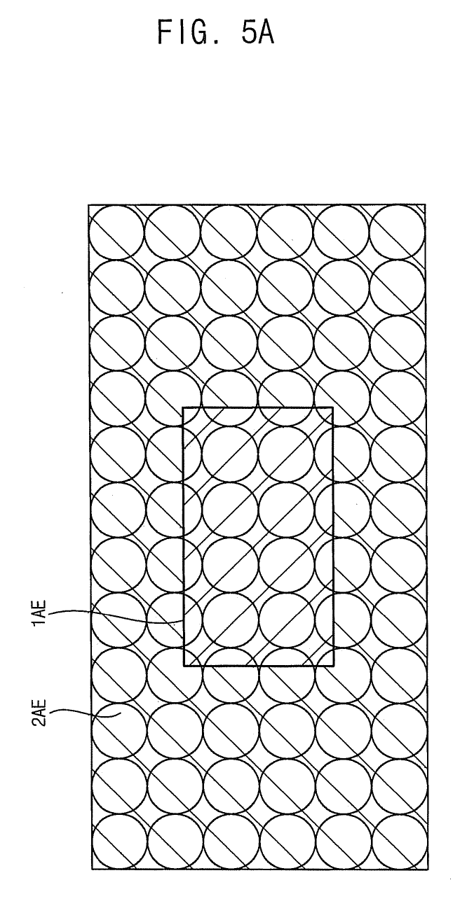

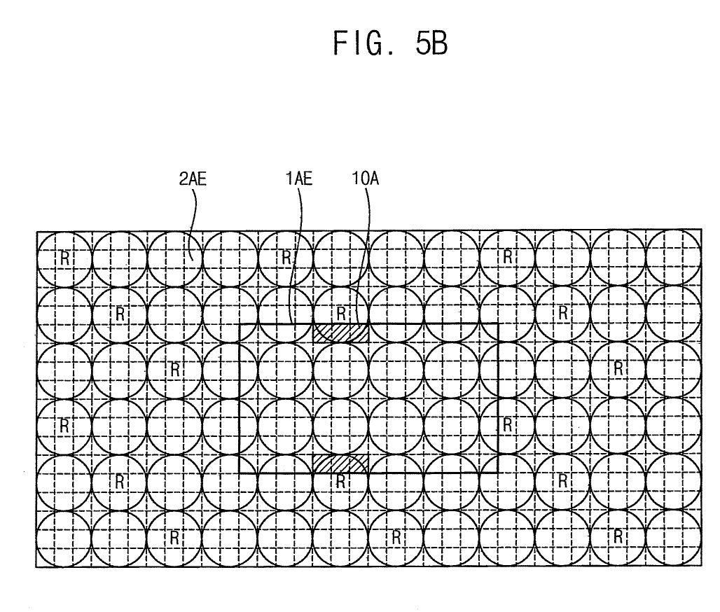

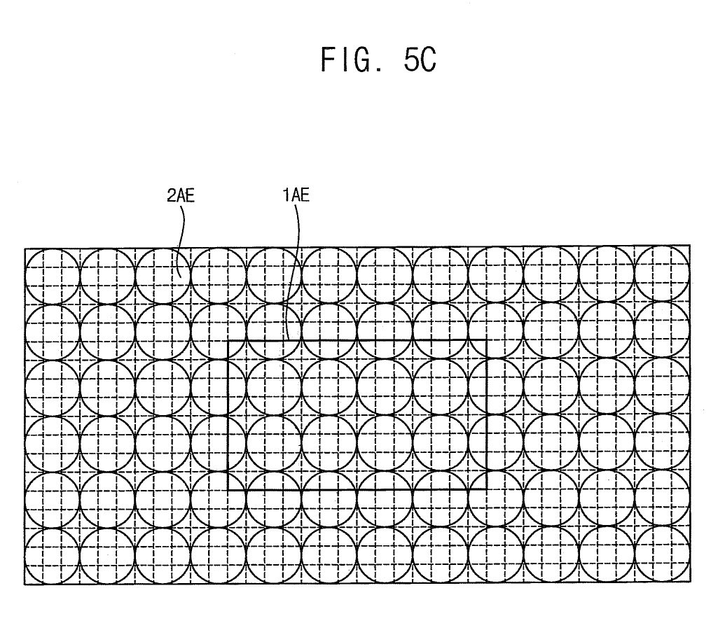

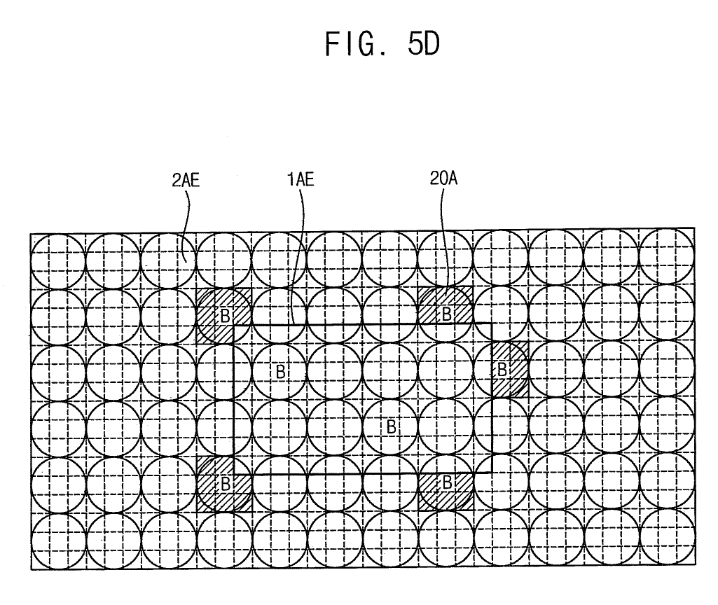

FIG. 5A is a cross-sectional view illustrating displayed images by a method of driving a display device in accordance with an exemplary embodiment of the present invention, and FIGS. 5B to 5D are cross-sectional views illustrating the method of driving the display device in order to display the images shown in FIG. 5A.

Referring to FIG. 5A, images displayed in a display device 500 in accordance with an exemplary embodiment of the present invention, for example, has a blue-colored central area 1AE and a red-colored peripheral area 2AE.

Referring to FIG. 5B, red LEDs R's and unit pixels 112 (see FIG. 4) of a display panel corresponding to the red LEDs R's are controlled to display red color in the peripheral area 2AE.

Particularly, a first red LED disposed within the peripheral area 2AE and a second red LED disposed across an interface between the central area 1AE and the peripheral area 2AE are selected to generate light. Simultaneously, unit pixels 112 corresponding to a first overlapping area 10A, which is a portion of the central area 1AE overlapping with the second red LED, are controlled to block red colored light generated from the second red LED. Here, the first and second red LEDs that are selected to generate light are represented by “R”, and red LEDs that are not selected to generate light are not marked by any denotation.

Referring to FIG. 5C, after the red color is displayed in the peripheral area 2AE, no green LEDs are driven. That is, green color is not displayed in any area in the display panel.

Referring to FIG. 5D, blue LEDs B's and unit pixels 112 of the display panel corresponding to the blue LEDs B's are controlled to display blue color in the central area 1AE.

Particularly, a first blue LED disposed within the central area 1AE and a second blue LED disposed across an interface between the central area 1AE and the peripheral area 2AE are selected to generate light. Simultaneously, unit pixels 112 corresponding to a second overlapping area 20A, which is a portion of the peripheral area 2AE overlapping with the second blue LED, are controlled to block blue color lights generated from the second blue LED. Here, the first and second blue LEDs that are selected to generate light are represented by “B”, and blue LEDs that are not selected to generate light are not marked by any denotation.

The images shown in FIG. 5A may be displayed by repeatedly performing the above-described steps to control the LEDs 220 and the unit pixels 112.

The LEDs 220 and the unit pixels 112 are individually driven so that light may be transmitted through arbitrary regions and so that light may be blocked in the other regions. Thus, images having various colors may be displayed in the display device 500.

According to the present invention, a control unit individually drives LEDs of a light emitting unit and unit pixels of a display panel so that regions through which light may be transmitted and regions through which light may not be transmitted are clearly differentiated. Thus, a contrast ratio is increased to improve an image display quality.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display device comprising:
a display panel assembly including a plurality of unit pixels and displaying an image;
a light emitting unit disposed under the display panel assembly to supply light to the display panel assembly, wherein the light emitting unit has a plurality of light emitting diodes (LEDs) corresponding to a unit pixel group including a given number of the unit pixels; and
a control unit electrically connected to the display panel assembly and the light emitting unit, wherein the control unit individually controls the unit pixels by arbitrary regions and individually controls the LEDs by arbitrary regions.

2. The display device of claim 1, wherein the LEDs comprise a red LED, a green LED and a blue LED.

3. The display device of claim 2, wherein the red LED, the green LED and the blue LED sequentially and repeatedly generate light.

4. The display device of claim 3, wherein each of the red LED, the green LED and the blue LED generates light at 60 Hz.

5. The display device of claim 1, wherein the unit pixel group comprises one unit pixel.

6. The display device of claim 1, wherein the unit pixel group comprises nine unit pixels.

7. The display device of claim 1, wherein the display panel assembly comprises:
a first substrate having TFTs formed in the unit pixels;
a second substrate facing the first substrate;
a liquid crystal layer interposed between the first and second substrates;
a printed circuit board (PCB) electrically connected to the control unit to change an image control signal applied by the control unit into a driving signal for driving the unit pixels; and
a flexible circuit film electrically connected to the display panel and the PCB.

8. The display device of claim 1, wherein the light emitting unit further comprises a driving substrate supplying source power to the LED.

9. A method of driving a display device comprising:
controlling a red LED and unit pixels of a display panel corresponding to the red LED to display red color in an arbitrary first region;
controlling a green LED and unit pixels of the display panel corresponding to the green LED to display green color in an arbitrary second region; and
controlling a blue LED and unit pixels of the display panel corresponding to the blue LED to display blue color in an arbitrary third region.

10. The method of claim 9, wherein controlling the red LED to display red color in the first region comprises:
controlling a first red LED and a second red LED to selectively generate light, the first red LED disposed within the first region, and the second red LED disposed across an interface between the first region and the other region; and
controlling unit pixels of the display panel corresponding to the second red LED to block light movement, wherein the unit pixels are disposed outside of the first region.

11. The method of claim 10, wherein controlling the first and second red LEDs to selectively generate light and controlling the unit pixels disposed outside of the first region are simultaneously performed.

12. The method of claim 9, wherein controlling the green LED to display green color in the second region comprises:
controlling a first green LED and a second green LED to selectively generate light, the first green LED disposed within the second region, and the second green LED disposed across an interface between the second region and the other region; and
controlling unit pixels of the display panel corresponding to the second green LED to block light movement, wherein the unit pixels are disposed outside of the second region.

13. The method of claim 12, wherein controlling the first and second green LEDs to selectively generate light and controlling the unit pixels disposed in the outside of the second region are simultaneously performed.

14. The method of claim 9, wherein controlling the blue LED to display blue color in the third region comprises:
controlling a first blue LED and a second blue LED to selectively generate light, the first blue LED disposed within the third region, and the second blue LED disposed across an interface between the third region and the other region; and
controlling unit pixels of the display panel corresponding to the second blue LED to block light movement, wherein the unit pixels are disposed outside of the third region.

15. The method of claim 14, wherein controlling the first and second blue LEDs to selectively generate light and controlling the unit pixels disposed outside of the third region are simultaneously performed.

16. The method of claim 9, wherein each of the LEDs corresponds to nine of the unit pixels.
